(19) United States
(12) Patent Application Publication
(10) Pub. No.: US 2026/0172482 A1
(43) Pub. Date: Jun. 18, 2026

(54) NETWORK FUNCTION DISCOVERY SUPPORTING MULTIPLE NETWORK FUNCTION DISCOVERY REQUESTS, AND RELATED DEVICES, METHODS AND COMPUTER PROGRAMS

(71) Applicant: NOKIA SOLUTIONS AND NETWORKS OY, Espoo (FI)

(72) Inventors: Xin Xin WANG, Shandong (CN); Bruno LANDAIS, Pleumeur-Bodou (FR); Horst Thomas BELLING, Erding (DE); Xin WANG, Shandong (CN); Han Xiao DU, Shandong (CN); Tao TIAN, Shandong (CN)

(21) Appl. No.: 19/127,402

(22) PCT Filed: Nov. 4, 2022
(86) PCT No.: PCT/CN2022/130105

§ 371 Date: May 5, 2025

(51) Int. Cl. H04L 67/51

(52) U.S. Cl. CPC H04L 67/51

(57) ABSTRACT

Devices, methods and computer programs for network function discovery supporting multiple network function discovery requests are disclosed. At least some example embodiments may allow a network function discovery that supports multiple network function discovery requests, thereby decreasing the number of messages to be exchanged in an NF discovery procedure, and/or lowering the latency and/or processing overhead in the processing of NF discovery requests.

### TECHNICAL FIELD

Various example embodiments described herein generally relate to communications and, more particularly but not exclusively, to a network function discovery supporting multiple network function discovery requests, as well as related devices, methods and computer programs.

### BACKGROUND

The core network (5GC) of fifth generation (5G) wireless networks has been defined as a service-based architecture (SBA) in which network function (NF) service producers may expose services to NF service consumers.

### SUMMARY

According to some example embodiments, there is provided the subject matter of the independent claims. Some further example embodiments are defined in the dependent claims. Example embodiments, corresponding features and/or aspects described herein that do not fall within the scope of the claims are to be interpreted as examples for understanding various example embodiments.

An example embodiment of an apparatus (e.g., first network node) comprises at least one processor and at least one memory storing instructions that, when executed by the at least one processor, cause the apparatus (e.g., first network node) at least to perform generating an NF discovery request message comprising at least two NF discovery requests. Each of the at least two NF discovery requests includes at least one query parameter describing a requested service or property of another apparatus (e.g., NF service producer). The instructions, when executed by the at least one processor, further cause the apparatus (e.g., first network node) at least to perform transmitting the generated NF discovery request message towards a further apparatus (e.g., a second network node device).

An example embodiment of a first network node device configured to function as a network function, NF, service consumer or a service communication proxy, SCP, the first network node device comprising at least one processor and at least one memory storing instructions that, when executed by the at least one processor, cause the first network node device at least to perform generating an NF discovery request message comprising at least two NF discovery requests.

Each of the at least two NF discovery requests includes at least one query parameter describing a requested service or property of an NF service producer. The instructions, when executed by the at least one processor, further cause the first network node device at least to perform transmitting the generated NF discovery request message towards a second network node device configured to function as a network repository function, NRF.

An example embodiment of an apparatus (e.g., first network node device) comprises at least one processor and at least one memory storing instructions that, when executed by the at least one processor, cause the apparatus (e.g., first network node) at least to perform generating an NF discovery request message comprising at least two NF discovery requests. Each of the at least two NF discovery requests includes at least one query parameter describing a requested service or property of another apparatus (e.g., NF service producer). The instructions, when executed by the at least one processor, further cause the apparatus (e.g., first network node) at least to perform transmitting the generated NF discovery request message towards a further apparatus (e.g., a second network node device). The instructions, when executed by the at least one processor, further cause the apparatus (e.g., first network node device) at least to perform receiving an NF discovery response message. The NF discovery response message comprises NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests.

An example embodiment of a first network node device configured to function as a network function, NF, service consumer or a service communication proxy, SCP, the first network node device comprising at least one processor and at least one memory storing instructions that, when executed by the at least one processor, cause the first network node device at least to perform generating an NF discovery request message comprising at least two NF discovery requests. Each of the at least two NF discovery requests includes at least one query parameter describing a requested service or property of an NF service producer. The instructions, when executed by the at least one processor, further cause the first network node device at least to perform transmitting the generated NF discovery request message towards a second network node device configured to function as a network repository function, NRF. The instructions, when executed by the at least one processor, further cause the first network node device at least to perform receiving an NF discovery response message. The NF discovery response message comprises NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests.

In an example embodiment, alternatively or in addition to the above-described example embodiments, the instructions, when executed by the at least one processor, further cause the first network node device to perform: for at least one of the NF discovery request specific NF discovery responses, selecting a network function and transmitting a service request towards the selected network function In an example embodiment, alternatively or in addition to the above-described example embodiments, the received NF discovery response message comprises a separate NF discovery response for each NF discovery request.

In an example embodiment, alternatively or in addition to the above-described example embodiments, the query parameters in each NF discovery request are included separately from each other in the NF discovery request message.

In an example embodiment, alternatively or in addition to the above-described example embodiments, the at least two NF discovery requests comprise a main NF discovery request and at least one auxiliary NF discovery request, and the query parameters in each auxiliary NF discovery request are included separately from each other in the NF discovery request message in NF discovery request message headers customized for carrying query parameters of an NF auxiliary discovery request and a unique discovery request identifier.

In an example embodiment, alternatively or in addition to the above-described example embodiments, discovery results matching each of the at least two NF discovery requests are included separately from discovery results matching another of the at least two NF discovery requests in the NF discovery response message.

In an example embodiment, alternatively or in addition to the above-described example embodiments, the NF discovery response message comprises a multipart NF discovery response message, and the matching NF profiles in each NF discovery response are included in separate parts of the multi-part NF discovery response message.

In an example embodiment, alternatively or in addition to the above-described example embodiments, each auxiliary discovery request is associated with a unique discovery request identifier.

In an example embodiment, alternatively or in addition to the above-described example embodiments, an NF discovery response for an auxiliary NF discovery request is associated with the unique discovery request identifier of the corresponding auxiliary NF discovery request.

In an example embodiment, alternatively or in addition to the above-described example embodiments, the instructions, when executed by the at least one processor, further cause the first network node device to perform generating a separate cache entry for each part of the multi-part NF discovery response message.

In an example embodiment, alternatively or in addition to the above-described example embodiments, the instructions, when executed by the at least one processor, further cause the first network node device to perform receiving at least one of error information or a redirection indication towards a third network node device configured to function as an NRF.

In an example embodiment, alternatively or in addition to the above-described example embodiments, the instructions, when executed by the at least one processor, further cause the first network node device to perform receiving at least two service requests, each comprising query parameters; generating an NF discovery request message comprising an NF discovery request for each of the received at least two service requests, each NF discovery request comprising at least one received query parameter; and for at least one of the NF discovery request specific NF discovery responses, selecting a network function and transmitting the received service request as a service request towards the selected network function.

An example embodiment of an apparatus (e.g., first network node device)comprises means for causing the first network node device to generate an NF discovery request message comprising at least two NF discovery requests. Each of the at least two NF discovery requests includes at least one query parameter describing a requested service or property of another apparatus (e.g., NF service producer). The means are further configured to cause the apparatus (e.g., first network node device) to transmit the generated NF discovery request message towards a further apparatus (e.g., second network node device).

An example embodiment of a first network node device configured to function as a network function, NF, service consumer or a service communication proxy, SCP, the first network node device comprising means for causing the first network node device to generate an NF discovery request message comprising at least two NF discovery requests. Each of the at least two NF discovery requests includes at least one query parameter describing a requested service or property of an NF service producer. The means are further configured to cause the first network node device to transmit the generated NF discovery request message towards a second network node device configured to function as a network repository function, NRF.

An example embodiment of an apparatus (e.g., first network node device) comprises means for causing the apparatus (e.g., first network node device) to generate an NF discovery request message comprising at least two NF discovery requests. Each of the at least two NF discovery requests includes at least one query parameter describing a requested service or property of another apparatus (e.g., NF service producer). The means are further configured to cause the apparatus (e.g., first network node device) to transmit the generated NF discovery request message towards a further apparatus (e.g., second network node device). The means are further configured to cause the apparatus (e.g., first network node device) to receive an NF discovery response message. The NF discovery response message comprises NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests.

An example embodiment of a first network node device configured to function as a network function, NF, service consumer or a service communication proxy, SCP, the first network node device comprising means for causing the first network node device to generate an NF discovery request message comprising at least two NF discovery requests. Each of the at least two NF discovery requests includes at least one query parameter describing a requested service or property of an NF service producer. The means are further configured to cause the first network node device to transmit the generated NF discovery request message towards a second network node device configured to function as a network repository function, NRF. The means are further configured to cause the first network node device to receive an NF discovery response message. The NF discovery response message comprises NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests.

In an example embodiment, alternatively or in addition to the above-described example embodiments, the means are further configured to cause the first network node device to: for at least one of the NF discovery request specific NF discovery responses, select a network function and transmit a service request towards the selected network function In an example embodiment, alternatively or in addition to the above-described example embodiments, the received NF discovery response message comprises a separate NF discovery response for each NF discovery request.

In an example embodiment, alternatively or in addition to the above-described example embodiments, the query parameters in each NF discovery request are included separately from each other in the NF discovery request message.

In an example embodiment, alternatively or in addition to the above-described example embodiments, the at least two NF discovery requests comprise a main NF discovery request and at least one auxiliary NF discovery request, and the query parameters in each auxiliary NF discovery request are included separately from each other in the NF discovery request message in NF discovery request message headers customized for carrying query parameters of an NF auxiliary discovery request and a unique discovery request identifier.

In an example embodiment, alternatively or in addition to the above-described example embodiments, discovery results matching each of the at least two NF discovery requests are included separately from discovery results matching another of the at least two NF discovery requests in the NF discovery response message.

In an example embodiment, alternatively or in addition to the above-described example embodiments, the NF discovery response message comprises a multipart NF discovery response message, and the matching NF profiles in each NF discovery response are included in separate parts of the multi-part NF discovery response message.

In an example embodiment, alternatively or in addition to the above-described example embodiments, each auxiliary discovery request is associated with a unique discovery request identifier.

In an example embodiment, alternatively or in addition to the above-described example embodiments, an NF discovery response for an auxiliary NF discovery request is associated with the unique discovery request identifier of the corresponding auxiliary NF discovery request.

In an example embodiment, alternatively or in addition to the above-described example embodiments, the means are further configured to cause the first network node device to generate a separate cache entry for each part of the multi-part NF discovery response message.

In an example embodiment, alternatively or in addition to the above-described example embodiments, the means are further configured to cause the first network node device to receive at least one of error information or a redirection indication towards a third network node device configured to function as an NRF.

In an example embodiment, alternatively or in addition to the above-described example embodiments, the means are further configured to cause the first network node device to receive at least two service requests, each comprising query parameters; generate an NF discovery request message comprising an NF discovery request for each of the received at least two service requests, each NF discovery request comprising at least one received query parameter; and for at least one of the NF discovery request specific NF discovery responses, select a network function and transmit the received service request as a service request towards the selected network function.

An example embodiment of a method comprises generating, by an apparatus (e.g., a first network node device), an NF discovery request message comprising at least two NF discovery requests. Each of the at least two NF discovery requests includes at least one query parameter describing a requested service or property of another apparatus (e.g., NF service producer). The method further comprises transmitting, by the apparatus (e.g., first network node device), the generated NF discovery request message towards a further apparatus (e.g., second network node device).

An example embodiment of a method comprises generating, by a first network node device configured to function as a network function, NF, service consumer or a service communication proxy, SCP, the first network node, an NF discovery request message comprising at least two NF discovery requests. Each of the at least two NF discovery requests includes at least one query parameter describing a requested service or property of an NF service producer. The method further comprises transmitting, by the first network node device, the generated NF discovery request message towards a second network node device configured to function as a network repository function, NRF.

An example embodiment of a method comprises generating, by an apparatus (e.g., a first network node device), an NF discovery request message comprising at least two NF discovery requests. Each of the at least two NF discovery requests includes at least one query parameter describing a requested service or property of another apparatus (e.g., NF service producer). The method further comprises transmitting, by the apparatus (e.g., first network node device), the generated NF discovery request message towards a further apparatus (e.g., second network node device). The method further comprises receiving, at the apparatus (e.g., first network node device), an NF discovery response message. The NF discovery response message comprises NF discovery request specific NF discovery responses for at least two NF discovery requests of the at least two NF discovery requests. At least some of the NF discovery responses include at least one NF profile of at least one candidate apparatus (e.g., candidate NF service producer) matching at least one query parameter included in a corresponding NF discovery request of the at least two NF discovery requests.

An example embodiment of a method comprises generating, by a first network node device configured to function as a network function, NF, service consumer or a service communication proxy, SCP, an NF discovery request message comprising at least two NF discovery requests. Each of the at least two NF discovery requests includes at least one query parameter describing a requested service or property of an NF service producer. The method further comprises transmitting, by the first network node device, the generated NF discovery request message towards a second network node device configured to function as a network repository function, NRF. The method further comprises receiving, at the first network node device, an NF discovery response message. The NF discovery response message comprises NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests.

In an example embodiment, alternatively or in addition to the above-described example embodiments, the method further comprises: for at least one of the NF discovery request specific NF discovery responses, selecting a network function and transmitting a service request towards the selected network function

In an example embodiment, alternatively or in addition to the above-described example embodiments, the received NF discovery response message comprises a separate NF discovery response for each NF discovery request

In an example embodiment, alternatively or in addition to the above-described example embodiments, the query parameters in each NF discovery request are included separately from each other in the NF discovery request message.

In an example embodiment, alternatively or in addition to the above-described example embodiments, the at least two NF discovery requests comprise a main NF discovery request and at least one auxiliary NF discovery request, and the query parameters in each auxiliary NF discovery request are included separately from each other in the NF discovery request message in NF discovery request message headers customized for carrying query parameters of an NF auxiliary discovery request and a unique discovery request identifier.

In an example embodiment, alternatively or in addition to the above-described example embodiments, discovery results matching each of the at least two NF discovery requests are included separately from discovery results matching another of the at least two NF discovery requests in the NF discovery response message.

In an example embodiment, alternatively or in addition to the above-described example embodiments, the NF discovery response message comprises a multipart NF discovery response message, and the matching NF profiles in each NF discovery response are included in separate parts of the multi-part NF discovery response message.

In an example embodiment, alternatively or in addition to the above-described example embodiments, each auxiliary discovery request is associated with a unique discovery request identifier.

In an example embodiment, alternatively or in addition to the above-described example embodiments, an NF discovery response for an auxiliary NF discovery request is associated with the unique discovery request identifier of the corresponding auxiliary NF discovery request.

In an example embodiment, alternatively or in addition to the above-described example embodiments, the method further comprises generating, by the first network node device, a separate cache entry for each part of the multi-part NF discovery response message.

In an example embodiment, alternatively or in addition to the above-described example embodiments, the method further comprises receiving, at the first network node device, at least one of error information or a redirection indication towards a third network node device configured to function as an NRF.

In an example embodiment, alternatively or in addition to the above-described example embodiments the method further comprises receiving at the first network node device at least two service requests, each comprising query parameters; generating by the first network node device an NF discovery request message comprising an NF discovery request for each of the received at least two service requests, each NF discovery request comprising at least one received query parameter; and for at least one of the NF discovery request specific NF discovery responses, selecting a network function and transmitting the received service request as a service request towards the selected network function.

An example embodiment of a computer program comprises instructions for causing an apparatus (e.g., first network node device) to perform at least the following: generating an NF discovery request message comprising at least two NF discovery requests, each of the at least two NF discovery requests including at least one query parameter describing a requested service or property of another apparatus (e.g., an NF service producer); and transmitting the generated NF discovery request message towards a further apparatus (e.g., second network node device).

An example embodiment of a computer program comprises instructions for causing a first network node device, configured to function as a network function, NF, service consumer or a service communication proxy, SCP, to perform at least the following: generating an NF discovery request message comprising at least two NF discovery requests, each of the at least two NF discovery requests including at least one query parameter describing a requested service or property of an NF service producer; and transmitting the generated NF discovery request message towards a second network node device configured to function as a network repository function, NRF.

An example embodiment of a computer program comprises instructions for causing an apparatus (e.g., first network node device) to perform at least the following: generating an NF discovery request message comprising at least two NF discovery requests, each of the at least two NF discovery requests including at least one query parameter describing a requested service or property of another apparatus (e.g., an NF service producer); transmitting the generated NF discovery request message towards a further apparatus (e.g., second network node device); and receiving an NF discovery response message comprising NF discovery request specific NF discovery responses for at least two NF discovery requests of the at least two NF discovery requests, at least some of the NF discovery responses including at least one NF profile of at least one candidate apparatus (e.g., at least one candidate NF service producer) matching at least one query parameter included in a corresponding NF discovery request of the at least two NF discovery requests.

An example embodiment of a computer program comprises instructions for causing a first network node device, configured to function as a network function, NF, service consumer or a service communication proxy, SCP, to perform at least the following: generating an NF discovery request message comprising at least two NF discovery requests, each of the at least two NF discovery requests including at least one query parameter describing a requested service or property of an NF service producer; transmitting the generated NF discovery request message towards a second network node device configured to function as a network repository function, NRF; and receiving an NF discovery response message comprising NF discovery request specific NF discovery responses for at least two NF discovery requests of the at least two NF discovery requests, at least some of the NF discovery responses including at least one NF profile of at least one candidate NF service producer matching at least one query parameter included in a corresponding NF discovery request of the at least two NF discovery requests.

An example embodiment of an apparatus (e.g., second network node device) comprises at least one processor and at least one memory storing instructions that, when executed by the at least one processor, cause the apparatus (e.g., second network node device) at least to perform receiving a network function, NF, discovery request message originating from a further apparatus (e.g., first network node device). The NF discovery request message comprises at least two NF discovery requests. Each of the at least two NF discovery requests includes at least one query parameter describing a requested service or property of another apparatus (e.g., NF service producer). The instructions, when executed by the at least one processor, further cause the apparatus (e.g., second network node device) at least to perform generating an NF discovery response message comprising NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests.

An example embodiment of a second network node device configured to function as a network repository function, NRF, comprises at least one processor and at least one memory storing instructions that, when executed by the at least one processor, cause the second network node device at least to perform receiving a network function, NF, discovery request message originating from a first network node device configured to function as an NF service consumer or as a service communication proxy, SCP. The NF discovery request message comprises at least two NF discovery requests. Each of the at least two NF discovery requests includes at least one query parameter describing a requested service or property of an NF service producer. The instructions, when executed by the at least one processor, further cause the second network node device at least to perform generating an NF discovery response message comprising NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests.

An example embodiment of an apparatus (e.g., second network node device) comprises at least one processor and at least one memory storing instructions that, when executed by the at least one processor, cause the apparatus (e.g., second network node device) at least to perform receiving a network function, NF, discovery request message originating from a further apparatus (e.g., first network node device). The NF discovery request message comprises at least two NF discovery requests. Each of the at least two NF discovery requests includes at least one query parameter describing a requested service or property of another apparatus (e.g., NF service producer). The instructions, when executed by the at least one processor, further cause the apparatus (e.g., second network node device) at least to perform generating an NF discovery response message comprising NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests. The instructions, when executed by the at least one processor, further cause the apparatus (e.g., second network node device) at least to perform transmitting the generated NF discovery response message towards the further apparatus (e.g., first network node device).

An example embodiment of a second network node device configured to function as a network repository function, NRF, comprises at least one processor and at least one memory storing instructions that, when executed by the at least one processor, cause the second network node device at least to perform receiving a network function, NF, discovery request message originating from a first network node device configured to function as an NF service consumer or a service communication proxy, SCP. The NF discovery request message comprises at least two NF discovery requests. Each of the at least two NF discovery requests includes at least one query parameter describing a requested service or property of an NF service producer. The instructions, when executed by the at least one processor, further cause the second network node device at least to perform generating an NF discovery response message comprising NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests. The instructions, when executed by the at least one processor, further cause the second network node device at least to perform transmitting the generated NF discovery response message towards the first network node device.

In an example embodiment, alternatively or in addition to the above-described example embodiments, the instructions, when executed by the at least one processor, further cause the second network node device to perform, in response to detecting an error affecting a subset of the NF discovery requests in the received NF discovery request message, including error information in the NF discovery response message for each affected NF discovery request.

In an example embodiment, alternatively or in addition to the above-described example embodiments, the instructions, when executed by the at least one processor, further cause the second network node device to perform transmitting a redirection indication for a subset of the NF discovery requests in the received NF discovery request message towards the first network node device. The redirection indication indicates that the subset of the NF discovery requests is to be redirected towards a third network node device configured to function as an NRF.

In an example embodiment, alternatively or in addition to the above-described example embodiments, the received NF discovery response message comprises a separate NF discovery response for each NF discovery request.

In an example embodiment, alternatively or in addition to the above-described example embodiments, the query parameters in each NF discovery request are included separately from each other in the NF discovery request message.

In an example embodiment, alternatively or in addition to the above-described example embodiments, the at least two NF discovery requests comprise a main NF discovery request and at least one auxiliary NF discovery request, and the query parameters in each auxiliary NF discovery request are included separately from each other in the NF discovery request message in NF discovery request message headers customized for carrying query parameters of an NF auxiliary discovery request and a unique discovery request identifier.

In an example embodiment, alternatively or in addition to the above-described example embodiments, discovery results matching each of the at least two NF discovery requests are included separately from discovery results matching another of the at least two NF discovery requests in the NF discovery response message.

In an example embodiment, alternatively or in addition to the above-described example embodiments, the NF discovery response message comprises a multipart NF discovery response message, and the matching NF profiles in each NF discovery response are included in separate parts of the multi-part NF discovery response message.

In an example embodiment, alternatively or in addition to the above-described example embodiments, each auxiliary discovery request is associated with a unique discovery request identifier.

In an example embodiment, alternatively or in addition to the above-described example embodiments, an NF discovery response for an auxiliary NF discovery request is associated with the unique discovery request identifier of the corresponding auxiliary NF discovery request.

An example embodiment of an apparatus (e.g., second network node device) comprises means for causing the apparatus (e.g., second network node device) to receive a network function, NF, discovery request message originating from a further apparatus (e.g., first network node device). The NF discovery request message comprises at least two NF discovery requests. Each of the at least two NF discovery requests includes at least one query parameter describing a requested service or property of another apparatus (e.g., NF service producer). The means are further configured to cause the apparatus (e.g., second network node device) to generate an NF discovery response message comprising NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests.

An example embodiment of a second network node device configured to function as a network repository function, NRF, comprises means for causing the second network node device to receive a network function, NF, discovery request message originating from a first network node device configured to function as an NF service consumer or a service communication proxy, SCP. The NF discovery request message comprises at least two NF discovery requests. Each of the at least two NF discovery requests includes at least one query parameter describing a requested service or property of an NF service producer. The means are further configured to cause the second network node device to generate an NF discovery response message comprising NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests.

An example embodiment of an apparatus (e.g., second network node device) comprises means for causing the apparatus (e.g., second network node device) to receive a network function, NF, discovery request message originating from a further apparatus (e.g., first network node device). The NF discovery request message comprises at least two NF discovery requests. Each of the at least two NF discovery requests includes at least one query parameter describing a requested service or property of another apparatus (e.g., NF service producer). The means are further configured to cause the apparatus (e.g., second network node device) to generate an NF discovery response message comprising NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests. The means are further configured to cause the apparatus (e.g., second network node device) to transmit the generated NF discovery response message towards the further apparatus (e.g., first network node device).

An example embodiment of a second network node device configured to function as a network repository function, NRF, comprises means for causing the second network node device to receive a network function, NF, discovery request message originating from a first network node device configured to function as an NF service consumer or a service communication proxy, SCP. The NF discovery request message comprises at least two NF discovery requests. Each of the at least two NF discovery requests includes at least one query parameter describing a requested service or property of an NF service producer. The means are further configured to cause the second network node device to generate an NF discovery response message comprising NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests. The means are further configured to cause the second network node device to transmit the generated NF discovery response message towards the first network node device.

In an example embodiment, alternatively or in addition to the above-described example embodiments, the means are further configured to cause the second network node device to, in response to detecting an error affecting a subset of the NF discovery requests in the received NF discovery request message, include error information in the NF discovery response message for each affected NF discovery request.

In an example embodiment, alternatively or in addition to the above-described example embodiments, the means are further configured to cause the second network node device to transmit a redirection indication for a subset of the NF discovery requests in the received NF discovery request message towards the first network node device. The redirection indication indicates that the subset of the NF discovery requests is to be redirected towards a third network node device configured to function as an NRF.

In an example embodiment, alternatively or in addition to the above-described example embodiments, the received NF discovery response message comprises a separate NF discovery response for each NF discovery request.

In an example embodiment, alternatively or in addition to the above-described example embodiments, the query parameters in each NF discovery request are included separately from each other in the NF discovery request message.

In an example embodiment, alternatively or in addition to the above-described example embodiments, the at least two NF discovery requests comprise a main NF discovery request and at least one auxiliary NF discovery request, and the query parameters in each auxiliary NF discovery request are included separately from each other in the NF discovery request message in NF discovery request message headers customized for carrying query parameters of an NF auxiliary discovery request and a unique discovery request identifier.

In an example embodiment, alternatively or in addition to the above-described example embodiments, discovery results matching each of the at least two NF discovery requests are included separately from discovery results matching another of the at least two NF discovery requests in the NF discovery response message.

In an example embodiment, alternatively or in addition to the above-described example embodiments, the NF discovery response message comprises a multipart NF discovery response message, and the matching NF profiles in each NF discovery response are included in separate parts of the multi-part NF discovery response message.

In an example embodiment, alternatively or in addition to the above-described example embodiments, each auxiliary discovery request is associated with a unique discovery request identifier.

In an example embodiment, alternatively or in addition to the above-described example embodiments, an NF discovery response for an auxiliary NF discovery request is associated with the unique discovery request identifier of the corresponding auxiliary NF discovery request.

An example embodiment of a method comprises receiving, at an apparatus (e.g., second network node device), NF, discovery request message originating from a further apparatus (e.g., first network node device). The NF discovery request message comprises at least two NF discovery requests. Each of the at least two NF discovery requests includes at least one query parameter describing a requested service or property of another apparatus (e.g., NF service producer). The method further comprises generating, by the apparatus (e.g., second network node device), an NF discovery response message comprising NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests.

An example embodiment of a method comprises receiving, at a second network node device configured to function as a network repository function, NRF, a network function, NF, discovery request message originating from a first network node device configured to function as an NF service consumer or a service communication proxy, SCP. The NF discovery request message comprises at least two NF discovery requests. Each of the at least two NF discovery requests includes at least one query parameter describing a requested service or property of an NF service producer. The method further comprises generating, by the second network node device, an NF discovery response message comprising NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests.

An example embodiment of a method comprises receiving, at an apparatus (e.g., second network node device), NF, discovery request message originating from a further apparatus (e.g., first network node device). The NF discovery request message comprises at least two NF discovery requests. Each of the at least two NF discovery requests includes at least one query parameter describing a requested service or property of another apparatus (e.g., NF service producer). The method further comprises generating, by the apparatus (e.g., second network node device), an NF discovery response message comprising NF discovery request specific NF discovery responses for at least two NF discovery requests of the at least two NF discovery requests. At least some of the NF discovery responses include at least one NF profile of at least one candidate apparatus (e.g., at least one candidate NF service producer) matching at least one query parameter included in a corresponding NF discovery request of the at least two NF discovery requests. The method further comprises transmitting, by the apparatus (e.g., second network node device), the generated NF discovery response message towards the further apparatus (e.g., first network node device).

An example embodiment of a method comprises receiving, at a second network node device configured to function as a network repository function, NRF, a network function, NF, discovery request message originating from a first network node device configured to function as an NF service consumer or a service communication proxy, SCP. The NF discovery request message comprises at least two NF discovery requests. Each of the at least two NF discovery requests includes at least one query parameter describing a requested service or property of an NF service producer. The method further comprises generating, by the second network node device, an NF discovery response message comprising NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests. The method further comprises transmitting, by the second network node device, the generated NF discovery response message towards the first network node device.

In an example embodiment, alternatively or in addition to the above-described example embodiments, the method further comprises, in response to detecting an error affecting a subset of the NF discovery requests in the received NF discovery request message, including error information in the NF discovery response message for each affected NF discovery request.

In an example embodiment, alternatively or in addition to the above-described example embodiments, the method further comprises transmitting a redirection indication for a subset of the NF discovery requests in the received NF discovery request message towards the first network node device. The redirection indication indicates that the subset of the NF discovery requests is to be redirected towards a third network node device configured to function as an NRF.

In an example embodiment, alternatively or in addition to the above-described example embodiments, the received NF discovery response message comprises a separate NF discovery response for each NF discovery request.

In an example embodiment, alternatively or in addition to the above-described example embodiments, the query parameters in each NF discovery request are included separately from each other in the NF discovery request message.

In an example embodiment, alternatively or in addition to the above-described example embodiments, the at least two NF discovery requests comprise a main NF discovery request and at least one auxiliary NF discovery request, and the query parameters in each auxiliary NF discovery request are included separately from each other in the NF discovery request message in NF discovery request message headers customized for carrying query parameters of an NF auxiliary discovery request and a unique discovery request identifier.

In an example embodiment, alternatively or in addition to the above-described example embodiments, discovery results matching each of the at least two NF discovery requests are included separately from discovery results matching another of the at least two NF discovery requests in the NF discovery response message.

In an example embodiment, alternatively or in addition to the above-described example embodiments, the NF discovery response message comprises a multipart NF discovery response message, and the matching NF profiles in each NF discovery response are included in separate parts of the multi-part NF discovery response message.

In an example embodiment, alternatively or in addition to the above-described example embodiments, each auxiliary discovery request is associated with a unique discovery request identifier.

In an example embodiment, alternatively or in addition to the above-described example embodiments, an NF discovery response for an auxiliary NF discovery request is associated with the unique discovery request identifier of the corresponding auxiliary NF discovery request.

An example embodiment of a computer program comprises instructions for causing an apparatus (e.g., second network node device) to perform at least the following: receiving a network function, NF, discovery request message originating from a further apparatus (e.g., first network node device), the NF discovery request message comprising at least two NF discovery requests, each of the at least two NF discovery requests including at least one query parameter describing a requested service or property of another apparatus (e.g., NF service producer); and generating an NF discovery response message comprising NF discovery request specific NF discovery responses for at least two NF discovery requests of the at least two NF discovery requests, at least some of the NF discovery responses including at least one NF profile of at least one candidate apparatus (e.g., at least one NF service producer) matching at least one query parameter included in a corresponding NF discovery request of the at least two NF discovery requests.

An example embodiment of a computer program comprises instructions for causing a second network node device configured to function as a network repository function, NRF, to perform at least the following: receiving a network function, NF, discovery request message originating from a first network node device configured to function as an NF service consumer or as a service communication proxy, SCP, the NF discovery request message comprising at least two NF discovery requests, each of the at least two NF discovery requests including at least one query parameter describing a requested service or property of an NF service producer; and generating an NF discovery response message comprising NF discovery request specific NF discovery responses for at least two NF discovery requests of the at least two NF discovery requests, at least some of the NF discovery responses including at least one NF profile of at least one candidate NF service producer matching at least one query parameter included in a corresponding NF discovery request of the at least two NF discovery requests.

An example embodiment of a computer program comprises instructions for causing an apparatus (e.g., second network node device) to perform at least the following: receiving a network function, NF, discovery request message originating from a further apparatus (e.g., first network node device), the NF discovery request message comprising at least two NF discovery requests, each of the at least two NF discovery requests including at least one query parameter describing a requested service or property of another apparatus (e.g., NF service producer); generating an NF discovery response message comprising NF discovery request specific NF discovery responses for at least two NF discovery requests of the at least two NF discovery requests, at least some of the NF discovery responses including at least one NF profile of at least one candidate apparatus (e.g., at least one NF service producer) matching at least one query parameter included in a corresponding NF discovery request of the at least two NF discovery requests; and transmitting the generated NF discovery response message towards the further apparatus (e.g., first network node device).

An example embodiment of a computer program comprises instructions for causing a second network node device configured to function as a network repository function, NRF, to perform at least the following: receiving a network function, NF, discovery request message originating from a first network node device configured to function as an NF service consumer or as a service communication proxy, SCP, the NF discovery request message comprising at least two NF discovery requests, each of the at least two NF discovery requests including at least one query parameter describing a requested service or property of an NF service producer; generating an NF discovery response message comprising NF discovery request specific NF discovery responses for at least two NF discovery requests of the at least two NF discovery requests, at least some of the NF discovery responses including at least one NF profile of at least one candidate NF service producer matching at least one query parameter included in a corresponding NF discovery request of the at least two NF discovery requests; and transmitting the generated NF discovery response message towards the first network node device.

### DESCRIPTION OF THE DRAWINGS

Some example embodiments will now be described with reference to the accompanying drawings:

FIG. 1 shows an example embodiment of the subject matter described herein illustrating an example system, where various example embodiments may be implemented;

FIG. 2A shows an example embodiment of the subject matter described herein illustrating a first network node device configured to function as a network function service consumer;

FIG. 2B shows an example embodiment of the subject matter described herein illustrating a second network node device configured to function as a network repository function; and

FIG. 3 shows example embodiments of the subject matter described herein illustrating methods.

Like reference numerals are used to designate like parts in the accompanying drawings.

### DETAILED DESCRIPTION

Reference will now be made in detail to example embodiments, which are illustrated in the accompanying drawings. The detailed description in connection with the appended drawings describes various example embodiments and is not intended to represent the only forms in which the various example embodiments may be constructed or utilized. The detailed description sets forth certain illustrative functions of various example embodiments and an illustrative sequence of steps for constructing and operating various example embodiments. However, the same or equivalent functions and sequences may be accomplished by different example embodiments.

Before describing in more detail, an example embodiment of a fifth generation (5G) core (5GC) network is briefly explained.

NF service consumers and/or service communication proxies (SCP) may discover NF service producers, e.g., by performing an NF discovery procedure. However, such an NF discovery procedure only supports a single NF discovery request per one NF discovery procedure. More specifically, only a single NF type value is allowed to be included for one NF discovery request.

Yet, at least in some situations, it may be advantageous to send two or more NF discovery requests for different target NF types by the same requesting entity. Currently, such two or more NF discovery requests are sent consecutively or one at a time. At least in some situations, this may, e.g., increase the number of messages to be exchanged, and/or add latency and/or processing overhead in the processing of the NF discovery requests. Accordingly, at least in some situations, it may be advantageous for a network function discovery that supports multiple (e.g., simultaneous) network function discovery requests.

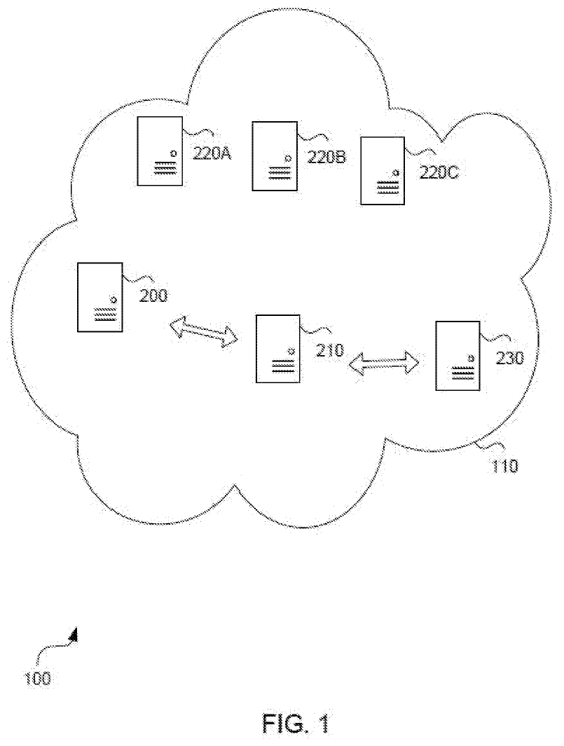

FIG. 1 illustrates an example system 100, where various example embodiments may be implemented. The system 100 may comprise a fifth generation (5G) core (5GC) network 110. An example representation of the system 100 is shown depicting network node devices 200, 210, 230, as well as NF service producers 220A, 220B, 220C.

The NF service producers 220A, 220B, 220C may register their NF profiles in a network repository function (NRF). An NF profile may comprise, e.g., NF level specific information and/or a list of NF service instances supported by the NF with their associated attributes.

NF service consumers and/or service communication proxies (SCP) may discover the NF service producers 220A, 220B, 220C, e.g., by performing an NF discovery procedure towards the NRF with query parameters describing the services or properties of the NF service producers they wish to discover. The NRF may return NF profiles of candidate NF service producers matching the query parameters in an NF discovery response. An NF discovery response may comprise NF profiles of multiple candidate NF service producers.

The network functions provided by the 5GC network 110 may include, e.g., any of the following: an access and mobility management function (AMF), a session management function (SMF), a user plane function (UPF), a policy control function (PCF), an authentication server function (AUSF), a unified data management (UDM), an application function (AF), a network exposure function (NEF), the network repository function (NRF), and a network slice selection function (NSSF).

At least in some example embodiments, the NF discovery procedure may be invoked by an NF service consumer (NFc) or a service communication proxy, SCP, the first network node requesting to discover a set of NF instances (and their associated NF service instances) represented by their NF profile. During the NF discovery procedure, the NFc or SCP may send, e.g., an HTTP (hypertext transfer protocol) GET request with a request URI (uniform resource identifier) including query parameters representing filter criteria for the discovery request.

For example, an NF service consumer or a service communication proxy may send an NF discovery request based on (e.g., due to) receiving a service request and handling the service request by sending the service request to a different NF service producer. As another example embodiment, an NF service consumer may send an NF discovery request due to receiving multiple service requests at the same time, and then sending discovery for these service requests in a single NF discovery request. More generally, this may also occur at the requesting NF or SCP when processing different and independent service requests in which the requesting NF or SCP discover and interact with different NFs matching different filter criteria (with the same or different NF types) almost at the same time.

In the following example embodiments, the first network node device 200 represent a network function (NF) service consumer, and the second and third network node devices 210, 230 represent NRFs.

At least in some example embodiments, a 5G network comprising the 5GC network 110 may comprise one or more massive machine-to-machine (M2M) network(s), massive machine type communications (mMTC) network(s), internet of things (IoT) network(s), industrial internet-of-things (IIoT) network(s), enhanced mobile broadband (eMBB) network(s), ultrareliable low-latency communication (URLLC) network(s), and/or the like. Thus, the 5G may be configured to serve diverse service types and/or use cases, and it may logically be seen as comprising one or more networks.

In the following, various example embodiments will be discussed. At least some of these example embodiments described herein may facilitate a network function discovery that supports multiple (e.g., simultaneous) network function discovery requests.

Accordingly, at least some of the example embodiments described herein may decrease the number of messages to be exchanged in an NF discovery procedure, and/or lower the latency and/or processing overhead in the processing of NF discovery requests.

Furthermore, at least some of the example embodiments described herein may facilitate a requesting entity to detect in advance errors that may result in stopping the processing of the request, e.g., when the requesting entity is to send multiple individual NF discovery requests for one particular processing (e.g., for a steering of roaming (SOR) procedure) but no candidate NF profile happens to match the filter criteria of a last NF discovery request.

At least some of the example embodiments described herein may thus allow enhancing the NF discovery procedure to enable an NFc or SCP to combine multiple discovery requests in one single NF discovery request message, and the NRF to return candidate NF profiles for each discovery request in a single NF discovery response message.

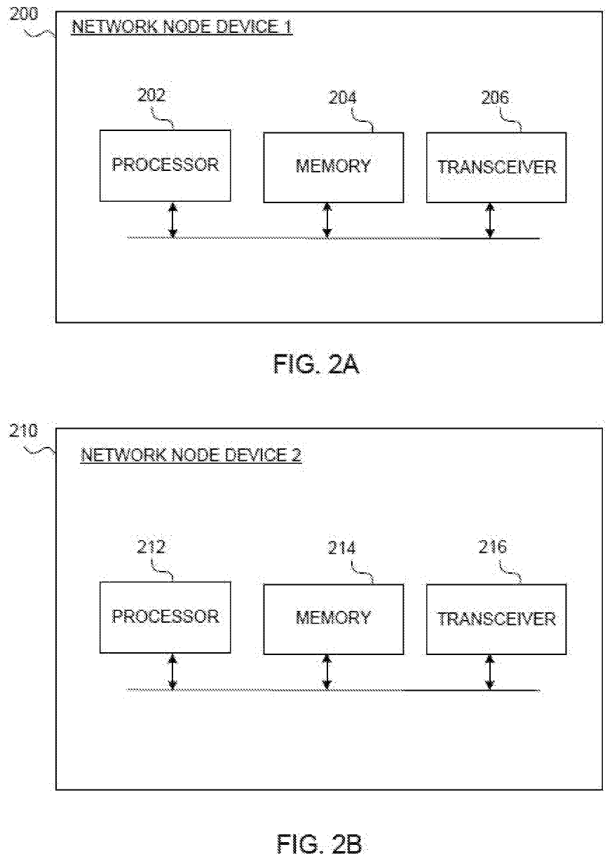

FIG. 2A is a block diagram of the first network node device 200 configured to function as an NF service consumer or a service communication proxy, in accordance with an example embodiment.

The first network node device 200 comprises one or more processors 202 and one or more memories 204 that comprise computer program code. The first network node device 200 may also include other elements, such as a transceiver 206 configured to enable the first network node device 200 to transmit and/or receive information to/from other devices, as well as other elements not shown in FIG. 2A.

Although the first network node device 200 is depicted to include only one processor 202, the first network node device 200 may include more processors. In an example embodiment, the memory 204 is capable of storing (e.g., configured to store) instructions, such as an operating system and/or various applications. Furthermore, the memory 204 may include a storage that may be used to store, e.g., at least some of the information and data used in the disclosed example embodiments.

Furthermore, the processor 202 is capable of executing (e.g., configured to execute) the stored instructions. In an example embodiment, the processor 202 may be implemented as a multi-core processor, a single core processor, or a combination of one or more multi-core processors and one or more single core processors. For example, the processor 202 may be implemented as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, or the like. In an example embodiment, the processor 202 may be configured to execute hard-coded functionality. In an example embodiment, the processor 202 is implemented as an executor of software instructions, wherein the instructions may specifically configure the processor 202 to perform the algorithms and/or operations described herein when the instructions are executed.

The memory 204 may be implemented as one or more volatile memory devices, one or more non-volatile memory devices, and/or a combination of one or more volatile memory devices and non-volatile memory devices. For example, the memory 204 may be implemented as semiconductor memories (such as mask ROM, PROM (programmable ROM), EPROM (erasable PROM), flash ROM, RAM (random access memory), etc.).

When executed by the at least one processor 202, instructions stored in the at least one memory 204 cause the first network node device 200 at least to perform generating an NF discovery request message comprising at least two NF discovery requests. Each of the at least two NF discovery requests includes at least one query parameter describing a requested service or property of an NF service producer 220A, 220B, 220C.

At least in some example embodiments, the query parameters in each NF discovery request may be included separately from each other in the NF discovery request message. When more than one discovery request is to be sent in one NF discovery request message, the NF discovery request message may be enhanced to enable conveying query parameters of each NF discovery request separately from other NF discovery requests yet combined within a same NF discovery request message.

For example, the at least two NF discovery requests may comprise a main NF discovery request and at least one auxiliary NF discovery request, and the query parameters in each auxiliary NF discovery request may be included separately from each other in the NF discovery request message in NF discovery request message headers customized for carrying query parameters of an NF auxiliary discovery request and a unique discovery request identifier. For example, a customized HTTP header (e.g., 3gpp-Sbi-Additional-Discovery) may be utilized in the NF discovery request to carry the query parameters of each auxiliary NF discovery request.

At least in some example embodiments, for the main discovery request, there may be a default discovery request identifier. Furthermore, at least in some example embodiments, the discovery response for the main discovery request may be linked to the default discovery request identifier.

In the following, example embodiments of such a customized header are described.

For example, the customized HTTP header (e.g., 3gpp-Sbi-Additional-Discovery) may contain a comma-delimited list of additional discovery parameters.

The encoding of the header may follow, e.g., a suitable augmented Backus-Naur form (ABNF), such as:
3gpp-Sbi-Additional-Discovery=“3gpp-Sbi-Additional-Discovery” “:” OWS “discovery-id=“token”;” OWS queryparameter #(“;” OWS queryparameter)
queryparameter=queryparametername “=” token.

Here, “queryparametername” may encode any query parameter supported by an NF discovery request.

At least in some example embodiments, the discovery-id parameter may allow uniquely identifying the auxiliary NF discovery request within the NF discovery request and response messages.

At least in some example embodiments, the 3gpp-Sbi-Additional-Discovery header may allow encoding any suitable combination of the discovery query parameters.

At least in some example embodiments, such a customized header may include, e.g., at least some of the following:
3gpp-Sbi-Additional-Discovery: discovery-id=1; requester-nf-type=UDM; service-names=nausf-sorprotection; target-nf-type=AUSF.

This header may be inserted multiple times in one NF discovery request to include different discovery criteria.

At least in some example embodiments, a Request-URI in a HTTP GET request may be used to convey the query parameters of a first discovery request.

At least in some example embodiments, an NF discovery request combining three discovery requests may include, e.g., at least some of the following:
HTTP GET . . . /nf-instances?requester-nf-type=UDM; service-names=nausf-sorprotection; target-nf-type=SOR-AF
3gpp-Sbi-Additional-Discovery: discovery-id=1; requester-nf-type=UDM; target-nf-type=SP-AF
3gpp-Sbi-Additional-Discovery: discovery-id=2; requester-nf-type=UDM; target-nf-type=AUSF.

The instructions, when executed by the at least one processor 202, further cause the first network node device 200 at least to perform transmitting the generated NF discovery request message towards the second network node device 210 configured to function as an NRF.

The instructions, when executed by the at least one processor 202, further cause the first network node device 200 at least to perform receiving an NF discovery response message. The NF discovery response message comprises NF discovery request specific NF discovery responses for at least two NF discovery requests of the at least two NF discovery requests. At least some of the NF discovery responses include at least one NF profile of at least one candidate NF service producer matching at least one query parameter included in a corresponding NF discovery request of the at least two NF discovery requests.

At least in some example embodiments, the instructions, when executed by the at least one processor 202, may further cause the first network node device 200 to perform: for at least one of the NF discovery request specific NF discovery responses, selecting a network function and transmitting a service request towards the selected network function.

For example, the selected network function may comprise any of the network functions provided by the 5GC network 110 described above in connection with FIG. 1.

At least in some example embodiments, the received NF discovery response message may comprise a separate NF discovery response for each NF discovery request.

At least in some example embodiments, discovery results matching each of the at least two NF discovery requests may be included separately from discovery results matching another of the at least two NF discovery requests in the NF discovery response message. When more than one discovery request is received in one NF discovery request message, the NF discovery response message may be enhanced to allow conveying the matching NF profiles of each discovery response separately from each other discovery response yet combined within a same NF discovery response message.

For example, the NF discovery response message may comprise a multi-part NF discovery response message, and the matching NF profiles in each NF discovery response may be included in separate parts of the multi-part NF discovery response message.

For example, an HTTP multi-part NF discovery response message may be utilized that includes multiple JavaScript object notation (JSON) parts, e.g., one part per each auxiliary NF discovery request in the NF discovery request message.

At least in some example embodiments, each auxiliary discovery request may be associated with a unique discovery request identifier. Furthermore, an NF discovery response for an auxiliary NF discovery request may be associated with the unique discovery request identifier of the corresponding auxiliary NF discovery request.

Each auxiliary NF discovery request may be associated with a discovery request identifier that allows the NF discovery response message to link returned NF profiles with the corresponding auxiliary NF discovery request. For example, a customized HTTP 3gpp-SBi-Status-Code (e.g., encoded in a body part of a multipart response message) or a customized 3gppSbi-Body-Part-Status header (e.g., encoded in a first part of a multipart response) in an NF discovery response may be utilized to carry a status code (e.g., a response code) of each NF discovery request in the NF discovery request message. Further, each JSON part in the NF discovery response may include, e.g., a Content-Id header set to the value of the NF discovery request identifier received in the NF discovery request message, to allow tying the JSON part with a specific NF discovery request.

For example, when an NRF receives an HTTP GET request with one or more 3gpp-Sbi-Additional-Discovery headers, the NRF may return, e.g., a “200 OK” message on success. The “200 OK” message may be formatted as an HTTP multipart message using, e.g., content type “multipart/related”, and comprising, e.g.:
one JSON body part with the “application/json” content type; and
one JSON body part with “application/json” content subtypes with header Content-Id, per an auxiliary discovery request.

An example embodiment of an NF discovery response message with two auxiliary discovery requests may include, e.g., at least some of the following:

```
  HTTP/2 200 OK
  Content-Type: multipart/related;
type=“application/json”; boundary=----Boundary
  Content-Length: xyz
  ------Boundary
  Content-Type: application/json
  {
    Existing JSON GET response corresponding
to query parameters in Request URI
  }
  ------Boundary
  Content-Type: application/json
  Content-Id: < identifier of auxiliary discov-
ery 1>
  {
    Existing JSON GET response for NF type of
auxiliary discovery header 1
  }
  ------Boundary
  Content-Type: application/json
  Content-Id: < identifier of auxiliary discov-
ery 2>
  {
    Existing JSON GET response for NF type of
auxiliary discovery header 2
  }
  ------Boundary
```

If a specific value is defined to be used as an identifier of the discovery parameters encoded in the Request URI of the HTTP Get request, e.g., discovery-id value 0 (zero), this value may be encoded in a Content-Id header part in the first JSON part of the NF discovery response message.

If no candidate profile is a match for an auxiliary NF discovery request, the corresponding JSON part in the NF discovery response message may encode an empty payload, e.g., as follows when no profiles match the last auxiliary discovery request:

```
  HTTP/2 200 OK
  Content-Type: multipart/related;
type=“application/json”; boundary=----Boundary
  Content-Length: xyz
  ------Boundary
  Content-Type: application/json
  {
      Existing JSON GET response corresponding
to query parameters in Request URI
  }
  ------Boundary
  Content-Type: application/json
  Content-Id: < identifier of auxiliary discov-
ery 1>
    {
      Existing JSON GET response for NF type of
auxiliary discovery header 1
  }
  ------Boundary
  Content-Type: application/json
  Content-Id: < identifier of auxiliary discov-
ery 2>
    {
  }.
```

At least in some example embodiments, the instructions, when executed by the at least one processor 202, may further cause the first network node device 200 to perform generating a separate cache entry for each part of the multi-part NF discovery response message. For example, caching logic at the NF service consumer may be enhanced so as to cache the returned profiles per each NF discovery request as if the NF service consumer had sent individual NF discovery requests.

For an NF discovery request message combining several discovery queries, for each auxiliary discovery query in the NF discovery request message, the receiver of the NF response message may generate a cache entry to cache the corresponding JSON part of the response message. A cache key may comprise the request URI with the query part set to the value of the corresponding 3gpp-Sbi-Additional-Discovery header, for example. At least in some example embodiments, this may allow caching the same information as if each auxiliary discovery query was performed using a conventional NF discovery procedure.

At least in some example embodiments, the NF discovery request message and/or the NF discovery response message may be communicated directly between the first network node device 200 and the second network node device 210. Alternatively, the NF discovery request message and/or the NF discovery response message may be communicated indirectly between the first network node device 200 and the second network node device 210, e.g., via a service communication proxy (SCP).

At least in some example embodiments, the instructions, when executed by the at least one processor 202, may further cause the first network node device 200 to perform receiving at least one of error information or a redirection indication towards a third network node device 230 configured to function as an NRF. At least in some example embodiments, the error information and/or the redirection indication may be included in the multi-part NF discovery response message.

At least in some example embodiments, the instructions, when executed by the at least one processor 202, may further cause the first network node device 200 to perform receiving at least two service requests, each comprising query parameters. The instructions, when executed by the at least one processor 202, may further cause the first network node device 200 to perform generating an NF discovery request message comprising an NF discovery request for each of the received at least two service requests, each NF discovery request comprising at least one received query parameter. The instructions, when executed by the at least one processor 202, may further cause the first network node device 200 to perform, for at least one of the NF discovery request specific NF discovery responses, selecting a network function and transmitting the received service request as a service request towards the selected network function.

FIG. 2B is a block diagram of the second network node device 210 configured to function as an NRF, in accordance with an example embodiment.

The second network node device 210 comprises at least one processor 212 and at least one memory 214 including computer program code. The second network node device 210 may also include other elements, such as a transceiver 216 configured to enable the second network node device 210 to transmit and/or receive information to/from other devices, as well as other elements not shown in FIG. 2B.

Although the second network node device 210 is depicted to include only one processor 212, the second network node device 210 may include more processors. In an example embodiment, the memory 214 is capable of storing (e.g., configured to store) instructions, such as an operating system and/or various applications. Furthermore, the memory 214 may include a storage that may be used to store, e.g., at least some of the information and data used in the disclosed example embodiments.

Furthermore, the processor 212 is capable of executing (e.g., configured to execute) the stored instructions. In an example embodiment, the processor 212 may be implemented as a multi-core processor, a single core processor, or a combination of one or more multi-core processors and one or more single core processors. For example, the processor 212 may be implemented as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, or the like. In an example embodiment, the processor 212 may be configured to execute hard-coded functionality. In an example embodiment, the processor 212 is implemented as an executor of software instructions, wherein the instructions may specifically configure the processor 212 to perform the algorithms and/or operations described herein when the instructions are executed.

The memory 214 may be implemented as one or more volatile memory devices, one or more non-volatile memory devices, and/or a combination of one or more volatile memory devices and non-volatile memory devices. For example, the memory 214 may be implemented as semiconductor memories (such as mask ROM, PROM (programmable ROM), EPROM (erasable PROM), flash ROM, RAM (random access memory), etc.).

When executed by the at least one processor 212, instructions stored in the at least one memory 214 cause the second network node device 210 at least to perform receiving the NF discovery request message originating from the first network node device 200 configured to function as the NF service consumer.

As discussed above in more detail, the NF discovery request message comprises at least two NF discovery requests. Each of the at least two NF discovery requests includes at least one query parameter describing a requested service or property of an NF service producer 220A, 220B, 220C.

The instructions, when executed by the at least one processor, further cause the second network node device 210 at least to perform generating an NF discovery response message comprising NF discovery request specific NF discovery responses for at least two NF discovery requests of the at least two NF discovery requests.

As discussed above in more detail, at least some of the NF discovery responses include at least one NF profile of at least one candidate NF service producer matching at least one query parameter included in a corresponding NF discovery request of the at least two NF discovery requests.

At least in some example embodiments, the instructions, when executed by the at least one processor 212, may further cause the second network node device 210 to perform, in response to detecting an error affecting a subset of the NF discovery requests in the received NF discovery request message, including error information in the NF discovery response message for each affected NF discovery request.

For example, the second network node device 210 (NRF) may return a successful response (e.g., a “200 OK” message) if an error is found affecting a sub-set of the NF discovery requests. In this case, the NF discovery response message may include error information (e.g., problem details) of each NF discovery request for which an error was found, in addition to returning the NF discovery response information (NF profiles) of the NF discovery requests that are processed successfully.

Examples of such errors may include, e.g., a mandatory query parameter missing, a requester NF not allowed to discover the NF services being queried, and/or an internal server error (e.g., overload).

A first example option to convey an error response may include, e.g., a customized HTTP header (e.g., 3gpp-Sbi-Status-Code) defined to enable encoding an HTTP status code (e.g., 200 OK, 400 Bad Request, or 403 Forbidden) in each body part of the multipart response.

A second example option to convey the error response may include, e.g., two customized HTTP headers (e.g., 3gpp-Sbi-Body-Part-Status and 3gpp-SbiBody-Part-Header) defined to enable encoding in the first part of the multipart response (e.g., not within a body part) an HTTP status code (e.g., 200 OK, 400 Bad Request, or 403 Forbidden) and headers with a Content-Id parameter set to the value of the discovery request identifier received in the NF discovery request message.

The second network node device 210 (NRF) may return an HTTP multi-part response message, but the JSON part of an NF discovery request that fails may contain the status code (e.g., in the customized HTTP header) and the same error response payload as if this request had been received alone in the NF discovery request, e.g., an optional ProblemDetails object.

The content-type of the JSON part may be set to, e.g., “application/josn+problem”. For example, content-id as 0 or no content-id may indicate the NF discovery response to the R-URI.

When an error is found for the auxiliary discovery 1 only, example multi-part messages with multiple JSON parts may include, e.g., at least some of the following:

```
  Option 1:
  HTTP/2 200 OK
```

| | |
|---|---|
| Content-Type: | multipart/related; |

```
type=″application/json″; boundary=----Boundary
  Content-Length: xyz
  ------Boundary
  Content-Type: application/json
  3gpp-SBi-Status-Code: 200 OK
  {
      Existing JSON GET response corresponding
to query parameters in Request URI
  }
  ------Boundary
  Content-Type: application/json+problem
  Content-Id: < identifier of auxiliary discov-
ery 1>
  3gpp-SBi-Status-Code: 400 Bad Request
  {
    “cause”: “MANDATORY_QUERY_PARAM_MISSING″
    ″invalidParams″: [ query: target-nf-type ]
  }
  ------Boundary
  Content-Type: application/json
  Content-Id: < identifier of auxiliary discov-
ery 2>
  3gpp-SBi-Status-Code: 200 OK
  {
      Existing JSON GET response for NF type of
auxiliary discovery header 2
  },
  or
  Option 2:
  HTTP/2 200 OK
```

| | |
|---|---|
| Content-Type: | multipart/related; |

type=″application/json″; boundary=----Boundary
Content-Length: xyz

| | |
|---|---|
| 3gpp-SBi-Body-Part-Status: | content-id=0; sta- |

tus-code= ″200 OK″

| | |
|---|---|
| 3gpp-SBi-Body-Part-Status: | content-id=1; sta- |

tus-code= ″400 Bad Request″

| | |
|---|---|
| 3gpp-SBi-Body-Part-Status: | content-id=2; sta- |

```
tus-code= ″200 OK″
  ------Boundary
  Content-Type: application/json
  Content-Id: 0
  {
      Existing JSON GET response corresponding
to query parameters in Request URI
  }
  ------Boundary
  Content-Type: application/json+problem
  Content-Id: 1
  {
    “cause”: “MANDATORY_QUERY_PARAM_MISSING″
    ″invalidParams″: [ query: target-nf-type ]
  }
  ------Boundary
  Content-Type: application/json
  Content-Id: 2
  {
      Existing JSON GET response for NF type of
auxiliary discovery header 2
  }.
```

At least in some example embodiments, the instructions, when executed by the at least one processor 212, may further cause the second network node device 210 to perform transmitting a redirection indication for a subset of the NF discovery requests in the received NF discovery request message towards the first network node device 200. The redirection indication may indicate that the subset of the NF discovery requests is to be redirected towards a third network node device 230 that may also be configured to function as an NRF.

For example, if the second network node device 210 (NRF) is to redirect the request to a different NRF for a specific discovery request in the NF request message while the second network node device 210 (NRF) can serve other discovery requests in the same NF request message (e.g., because a different NRF should be contacted for the discovery of NFs of a particular NF type), the second network node device 210 (NRF) may do so by, e.g., setting the HTTP custom header 3gpp-SBi-Status-Code (option 3) or 3gpp-SBi-Body-Part-Status (option 4) to a 3xx status code, and with the JSON part containing the same content as if this request had been received alone in the NF discovery request, e.g., an optional RedirectResponse object.

In option 3, the location header may also be included in the corresponding JSON part of the HTTP response, if available, to indicate the URI of the target NRF towards which the request is redirected. In option 4, the location header may be included in customized HTTP headers (e.g., 3gpp-Sbi-Body-Part-Header) in the first part of the multipart response (e.g., not within a body part).

For example, the content-type of the JSON part may be set to “application/json+redirect”.

When only an auxiliary discovery 1 is redirected to another NRF, example messages may include, e.g., at least some of the following:

| Option 3: | |
|---|---|
| HTTP/2 200 OK | |
| Content-Type: | multipart/related; |
| type=″application/json″; boundary=----Boundary | |
| Content-Length: xyz | |
| ------Boundary | |
| Content-Type: application/json | |
| 3gpp-SBi-Status-Code: 200 OK | |
| { | |
| Existing JSON GET response corresponding | |
| to query parameters in Request URI | |
| } | |
| ------Boundary | |
| Content-Type: application/json+redirect | |
| Content-Id: < identifier of auxiliary discov- | |
| ery 1> | |
| 3gpp-SBi-Status-Code: 307 temporary redirect | |
| Location: < URI of redirected-to NRF> | |
| { | |
| “cause”: “ xxxx ″ | |
| } | |
| ------Boundary | |
| Content-Type: application/json | |
| Content-Id: < identifier of auxiliary discov- | |
| ery 2> | |
| 3gpp-SBi-Status-Code: 200 OK | |
| { | |
| Existing JSON GET response for NF type of | |
| auxiliary discovery header 2 | |
| }, | |
| or | |
| Option 4: | |
| HTTP/2 200 OK | |
| Content-Type: | multipart/related; |
| type=″application/json″; boundary=----Boundary | |
| Content-Length: xyz | |
| 3gpp-SBi-Body-Part-Status: | content-id=0; sta- |
| tus-code= ”200 OK” | |
| 3gpp-SBi-Body-Part-Status: | content-id=1; sta- |
| tus-code= ”307 temporary redirect” | |
| 3gpp-SBi-Body-Part-Status: | content-id=2; sta- |
| tus-code= ”200 OK” | |
| 3gpp-SBi-Body-Part-Header: | content-id=1; Lo- |

```
cation= < URI of redirected-to NRF >
    ------Boundary
  Content-Type: application/json
  Content-Id: 0
  {
      Existing JSON GET response corresponding
to query parameters in Request URI
  }
  ------Boundary
  Content-Type: application/json+redirect
  Content-Id: 1
  {
    “cause”; “ xxxx ″
  }
  ------Boundary
  Content-Type: application/json
  Content-Id: 2
  {
      Existing JSON GET response for NF type of
auxiliary discovery header 2
  }
```

The instructions, when executed by the at least one processor, further cause the second network node device 210 at least to perform transmitting the generated NF discovery response message towards the first network node device 200.

Further features (such as those related to the NF discovery request message and the NF discovery response message, and the like) of the second network node device 210 directly result from the functionalities and parameters of the first network node device 200 and thus are not repeated here.

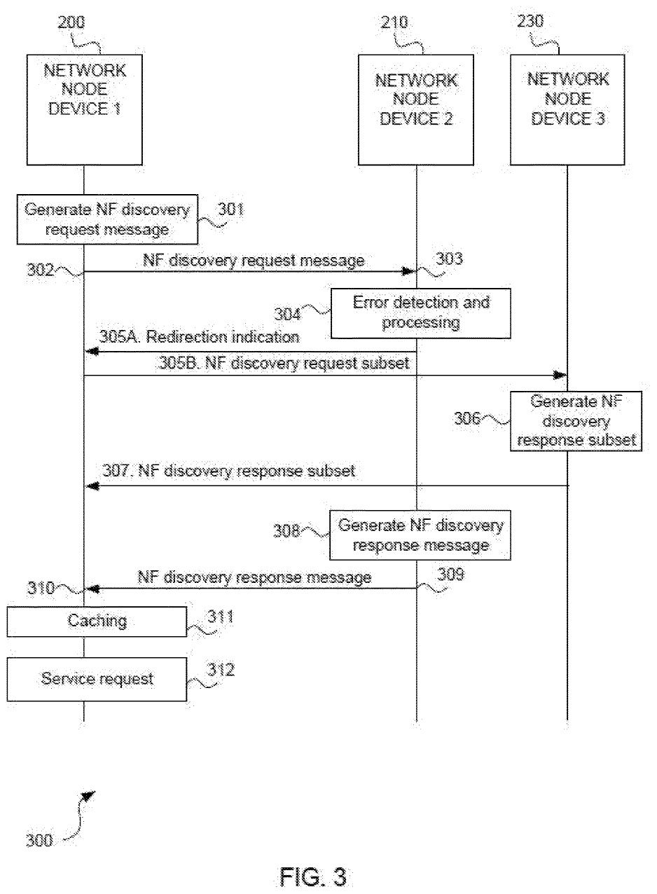

FIG. 3 illustrates an example signalling diagram 300 of methods, in accordance with example embodiments.

At operation 301, the first network node device 200, configured to function as a NF service consumer or a service communication proxy, generates the NF discovery request message comprising at least two NF discovery requests. As discussed above in more detail, each of the at least two NF discovery requests includes at least one query parameter describing a requested service or property of an NF service producer 220A, 220B, 220C.

At operation 302, the first network node device 200 transmits the generated NF discovery request message towards the second network node device 210 configured to function as the NRF. At operation 303, the second network node device 210 receives the NF discovery request message originating from the first network node device 200 configured to function as the NF service consumer or the service communication proxy.

At optional operation 304, the second network node device 210 may, based on (e.g., in response to) detecting an error affecting a subset of the NF discovery requests in the received NF discovery request message, include error information in the NF discovery response message to be generated for each affected NF discovery request.

At optional operation 305A, the second network node device 210 may transmit a redirection indication for a subset of the NF discovery requests in the received NF discovery request message towards the first network node device 200. The redirection indication indicates that the subset of the NF discovery requests is to be redirected towards a third network node device 230 configured to function as an NRF. At optional operation 305B, the first network node device 200 may transmit the subset of the NF discovery requests towards the third network node device 230 in accordance with the received redirection indication. At optional operation 306, the third network node device 230 may generate a corresponding NF discovery response subset, and transmit the generated NF discovery response subset towards the first network node device 200 at optional operation 307.

At operation 308, the second network node device 210 generates the NF discovery response message comprising the NF discovery request specific NF discovery responses for at least two NF discovery requests of the at least two NF discovery requests. As discussed above in more detail, at least some of the NF discovery responses include at least one NF profile of at least one candidate NF service producer matching at least one query parameter included in a corresponding NF discovery request of the at least two NF discovery requests.

At operation 309, the second network node device 210 transmits the generated NF discovery response message towards the first network node device 200. At operation 310, the first network node device 200 receives the NF discovery response message.

At optional operation 311, the first network node device 200 may generate a separate cache entry for each part of the multi-part NF discovery response message.

At optional operation 312, the first network node device 200 may, for at least one of the NF discovery request specific NF discovery responses, select a network function and transmit a service request towards the selected network function.

At least parts of the methods of diagram 300 may be performed by the first network node device 200 of FIG. 2A and the second network node device 210 of FIG. 2B. The operations 301-302, 305B, 307, 310, 311, 312 can, for example, be performed by the at least one processor 202 and the at least one memory 204. The operations 303, 304, 305A, 308, 309 can, for example, be performed by the at least one processor 212 and the at least one memory 214. Further features of the methods of diagram 300 directly result from the functionalities and parameters of the first network node device 200 and the second network node device 210, and thus are not repeated here. The methods of diagram 300 can be performed by computer program(s).

The first network node device 200 may comprise means for performing at least one method described herein. In one example, the means may comprise the at least one processor 202, and the at least one memory 204 storing instructions that, when executed by the at least one processor, cause the first network node device 200 to perform the method.

The second network node device 210 may comprise means for performing at least one method described herein. In one example embodiment, the means may comprise the at least one processor 212, and the at least one memory 214 storing instructions that, when executed by the at least one processor, cause the second network node device 210 to perform the method.

The functionality described herein can be performed, at least in part, by one or more computer program product components such as software components. According to an example embodiment, the first network node device 200 and/or second the network node device 210 may comprise a processor or processor circuitry, such as for example a microcontroller, configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

At least some example embodiments may be implemented using circuitry. The circuitry may be configured to perform one or more of the functions and/or method steps previously described. That circuitry may be provided in the base station and/or in the communications device and/or in a core network entity.

As used herein, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as a network node device, a communications device or a base station, to perform the various functions previously described; and
(c) hardware circuit(s) and or processor(s), such as a microprocessor(s) or a portion of a microprocessor(s), that requires software (e.g., firmware) for operation, but the software may not be present when it is not utilized for operation.

This definition of circuitry applies to all uses of this term herein, including in any claims. As a further example, as used in herein, the term circuitry also covers an implementation of merely a hardware circuit or processor (or multiple processors) or portion of a hardware circuit or processor and its (or their) accompanying software and/or firmware. The term circuitry also covers, for example integrated device.

The term “non-transitory,” as used herein, is a limitation of the medium itself (e.g., tangible, not a signal) as opposed to a limitation on data storage persistency (e.g., RAM vs. ROM).

Any range or device value given herein may be extended or altered without losing the effect sought. Also, any example embodiment may be combined with another example embodiment unless explicitly disallowed.

Although the subject matter has been described in language specific to structural features and/or acts, it is to be understood that the subject matter defined in the example embodiments is not necessarily limited to the specific features or acts described above. Rather, the specific features and acts described above are disclosed as illustrative examples of implementing the example embodiments and other equivalent features and acts are intended to be within the scope of the example embodiments.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, concurrently or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

It will be understood that the foregoing is provided by way of example only and that various modifications may be made by those skilled in the art. Although various example embodiments have been described above with a certain degree of particularity, or with reference to one or more individual example embodiments, those skilled in the art could make numerous alterations to the disclosed example embodiments without departing from the spirit or scope thereof.

1. A first network node device configured to function as a network function, NF, service consumer or a service communication proxy, SCP, the first network node device comprising:
at least one processor; and
at least one memory storing instructions that, when executed by the at least one processor, cause the first network node device at least to perform:
generating an NF discovery request message comprising at least two NF discovery requests, each of the at least two NF discovery requests including at least one query parameter describing a requested service or property of an NF service producer;
transmitting the generated NF discovery request message towards a second network node device configured to function as a network repository function, NRF; and
receiving an NF discovery response message, the NF discovery response message comprising NF discovery request specific NF discovery responses for at least two NF discovery requests of the at least two NF discovery requests, at least some of the NF discovery responses including at least one NF profile of at least one candidate NF service producer matching at least one query parameter included in a corresponding NF discovery request of the at least two NF discovery requests.

2. The first network node device according to claim 1, wherein the instructions, when executed by the at least one processor, further cause the first network node device to perform: for at least one of the NF discovery request specific NF discovery responses, selecting a network function and transmitting a service request towards the selected network function.

3. The first network node device according to claim 1, wherein the received NF discovery response message comprises a separate NF discovery response for each NF discovery request.

4. The first network node device according to claim 1, wherein the query parameters in each NF discovery request are included separately from each other in the NF discovery request message.

5. The first network node device according to claim 1, wherein the at least two NF discovery requests comprise a main NF discovery request and at least one auxiliary NF discovery request, and the query parameters in each auxiliary NF discovery request are included separately from each other in the NF discovery request message in NF discovery request message headers customized for carrying query parameters of an NF auxiliary discovery request and a unique discovery request identifier.

6. The first network node device according to claim 5, wherein discovery results matching each of the at least two NF discovery requests are included separately from discovery results matching another of the at least two NF discovery requests in the NF discovery response message.

7. The first network node device according to claim 6, wherein the NF discovery response message comprises a multi-part NF discovery response message, and the matching NF profiles in each NF discovery response are included in separate parts of the multi-part NF discovery response message.

8. The first network node device according to claim 5, wherein each auxiliary discovery request is associated with a unique discovery request identifier.

9. The first network node device according to claim 7, wherein an NF discovery response for an auxiliary NF discovery request is associated with the unique discovery request identifier of the corresponding auxiliary NF discovery request.

10. The first network node device according to claim 7, wherein the instructions, when executed by the at least one processor, further cause the first network node device to perform generating a separate cache entry for each part of the multi-part NF discovery response message.

11. The first network node device according to claim 1, wherein the instructions, when executed by the at least one processor, further cause the first network node device to perform receiving at least one of error information or a redirection indication towards a third network node device configured to function as an NRF.

12. The first network node device according to claim 1, wherein the instructions, when executed by the at least one processor, further cause the first network node device to perform:
receiving at least two service requests, each comprising query parameters; generating an NF discovery request message comprising an NF discovery request for each of the received at least two service requests, each NF discovery request comprising at least one received query parameter; and
for at least one of the NF discovery request specific NF discovery responses, selecting a network function and transmitting the received service request as a service request towards the selected network function.

13. A method, comprising:
generating, by a first network node device configured to function as a network function, NF, service consumer or a service communication proxy, SCP, an NF discovery request message comprising at least two NF discovery requests, each of the at least two NF discovery requests including at least one query parameter describing a requested service or property of an NF service producer;
transmitting, by the first network node device, the generated NF discovery request message towards a second network node device configured to function as a network repository function, NRF; and
receiving, at the first network node device, an NF discovery response message comprising NF discovery request specific NF discovery responses for at least two NF discovery requests of the at least two NF discovery requests, at least some of the NF discovery responses including at least one NF profile of at least one candidate NF service producer matching at least one query parameter included in a corresponding NF discovery request of the at least two NF discovery requests.

14. (canceled)

15. A second network node device configured to function as a network repository function, NRF, comprising:
at least one processor; and
at least one memory storing instructions that, when executed by the at least one processor, cause the second network node device at least to perform:
receiving a network function, NF, discovery request message originating from a first network node device configured to function as an NF service consumer or a service communication proxy, SCP, the NF discovery request message comprising at least two NF discovery requests, each of the at least two NF discovery requests including at least one query parameter describing a requested service or property of an NF service producer;
generating an NF discovery response message comprising NF discovery request specific NF discovery responses for at least two NF discovery requests of the at least two NF discovery requests, at least some of the NF discovery responses including at least one NF profile of at least one candidate NF service producer matching at least one query parameter included in a corresponding NF discovery request of the at least two NF discovery requests; and
transmitting the generated NF discovery response message towards the first network node device.

16. The second network node device according to claim 15, wherein the instructions, when executed by the at least one processor, further cause the second network node device to perform:
in response to detecting an error affecting a subset of the NF discovery requests in the received NF discovery request message, including error information in the NF discovery response message for each affected NF discovery request.

17. The second network node device according to claim 15, wherein the instructions, when executed by the at least one processor, further cause the second network node device to perform:
transmitting a redirection indication for a subset of the NF discovery requests in the received NF discovery request message towards the first network node device, the redirection indication indicating that the subset of the NF discovery requests is to be redirected towards a third network node device configured to function as an NRF.

18-19. (canceled)
